(19) United States
(12) Patent Application Publication
(10) Pub. No.: US 2022/0113857 A1
(43) Pub. Date: Apr. 14, 2022

(54) SYSTEMS AND METHODS FOR WEB-BASED SALES ENABLEMENT PLATFORMS

(71) Applicant: LUCKEYOU, INC.

(72) Inventors: Timothy Dingersen, Chappaqua, NY (US); Manuel Fernández, St. Laurent (CA)

(21) Appl. No.: 17/066,427

(22) Filed: Oct. 8, 2020

(51) Int. Cl. G06F 3/0484; G06F 40/186

(52) U.S. Cl. CPC G06F 3/04842; H04L 67/12; G06F 40/186

(57) ABSTRACT

There is provided a system comprising a memory storing databases, design assets, and an executable code, and a processor executing the code to receive a user input selecting a smart structure template from the smart structure template database, wherein the smart structure template includes a framework for an approved presentation based on template restrictions, receive a first customization input selecting a first design asset for creating the approved presentation using the smart structure template, insert the first design asset in the smart structure template based on a first template restriction associated with the first design asset, receive a second customization input selecting a second design asset for creating the approved presentation using the smart structure template, insert the second design asset in the smart structure template based on a second template restriction associated with the second design asset, and save a master version of the approved presentation in the memory.

### RELATED APPLICATION(S)

The present application claims the benefit of and priority to a U.S. Provisional Patent Application Ser. No. 62/912,627, filed Oct. 8, 2019, which is hereby incorporated by reference in its entirety into the present application.

### BACKGROUND

Sales presentations are an important part of an organization's identity. Traditional sales presentations are standardized by executive level decision makers to ensure consistency with the brand and identity. This uniformity ensures that all clients receive the same details and the same presentation, regardless of the location or status of the client, and independent from the position of the salesperson in the organization. However, certain products or services may benefit from regional specificity, and a salesperson's position in an organization and familiarity with a client may allow a more effective presentation that is different than the organization's standard presentation. An improved sales presentation platform will enable improved presentations.

### SUMMARY

The present disclosure is directed to systems and methods for web-based sales enablement platforms, substantially as shown in and/or described in connection with at least one of the figures, as set forth more completely in the claims.

In some implementations, the system comprises a non-transitory memory storing a user database, a company database, design assets, a smart structure template database, and an executable code, and a hardware processor executing the executable code to receive a user input selecting a smart structure template from the smart structure template database, wherein the smart structure template includes a framework for an approved presentation based on one or more template restrictions, receive a first customization input selecting a first design asset for creating the approved presentation using the smart structure template, insert the first design asset in the smart structure template based on a first template restriction associated with the first design asset, receive a second customization input selecting a second design asset for creating the approved presentation using the smart structure template, insert the second design asset in the smart structure template based on a second template restriction associated with the second design asset, and save a master version of the approved presentation in the non-transitory memory.

In other implementations, the hardware processor further executes the executable code to transmit the approved presentation to a user device for display.

In other implementations, the user device stores the approved presentation in a user device memory.

In other implementations, the approved presentation stored on the user device is synchronized with the master version of the approved presentation.

In other implementations, the approved presentation is displayed by the user device at a remote user location.

In other implementations, the approved presentation includes a link to access a third-party service.

In other implementations, the approved presentation includes a plurality of sections.

In other implementations, each design asset has an order restriction that governs a placement of the asset in the approved presentation.

In other implementations, the template permissions include at least one of an order permission, a font permission, a color permission, and a graphics permission.

In other implementations, the user input is restricted based on a user permission.

### BRIEF DESCRIPTION OF THE DRAWINGS

FIG. 1 shows a diagram of an exemplary web-based sales enablement platforms, according to one implementation of the present disclosure; and

FIG. 2 shows a diagram showing aspects of the web-based sales enablement platforms of FIG. 1, according to one implementation of the present disclosure;

FIG. 3 a flowchart illustrating an exemplary method of web-based sales enablement platforms, according to one implementation of the present disclosure.

### DETAILED DESCRIPTION

The following description contains specific information pertaining to implementations in the present disclosure. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale and are not intended to correspond to actual relative dimensions.

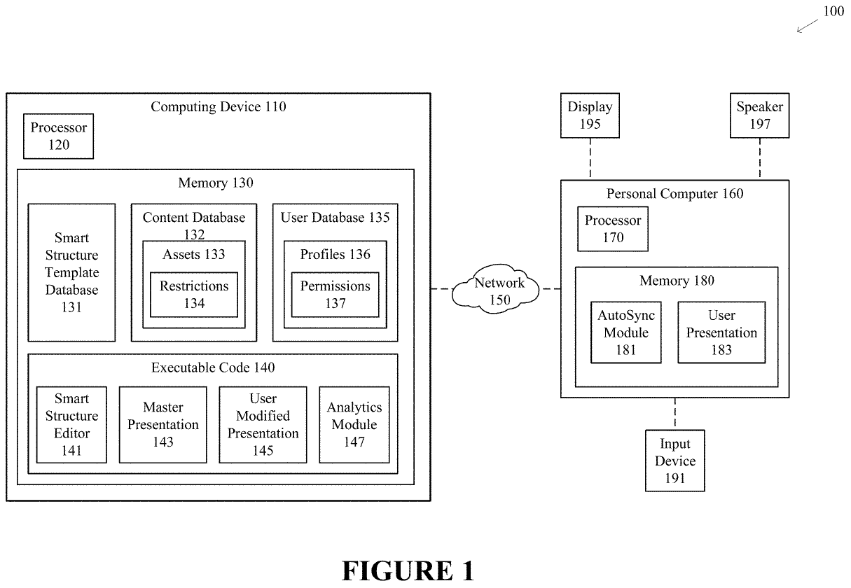

FIG. 1 shows a diagram of an exemplary web-based sales enablement platforms, according to one implementation of the present disclosure. System 100 includes computing device 110, network 150, personal computer 160, input device 191, display 195, and speaker 197. Computing device 110 is a is a computing device, which includes processor 120 and memory 130. Processor 120 is a hardware processor, such as a central processing unit (CPU) used in computing devices. Memory 130 is a non-transitory storage device for storing software for execution by processor 120, and also storing various data and parameters. Memory 130 includes smart structure template database 131, content database 132, user database 135, and executable code 140. In some implementations, computing device 110 may connect with personal computer 160 via network 150. Network 150 may be a computer network, such as the Internet.

Smart structure template database 131 is a database for storing assets including various slide show structures that may be used to create slideshow presentations. Smart structure template database 131 may include a plurality of presentation templates. The templates may be customizable to allow a user to create a customized presentation. In some implementations, smart structure template database 131 may include templates allowing editing, creation, and customizing of slide show presentations. A smart structure template may include rules governing an order of presentation materials, a content of presentation materials, different levels of customizability based on a permission of an asset or a permission of a user. The smart structure templates stored in smart structure template database 131 may allow a company to accomplish brand consistency across a wide range of users and regions, while simultaneously allowing users or teams to create unique presentations.

Content database 132 is a database storing various slides and assets that can be used in creating customized presentations. As shown in FIG. 1, content database 132 includes assets 133. Assets 133 may include presentation slides, graphics, such as tree-dimensional (3-D) rendering of products, video clips, and other visual and audio resources that the user may use for a presentation, such as a sales presentation. The content that is available to create a new slide may be selected from assets 133, including images, videos, animations, renderings of products, such as interactive three-dimensional (3D) renderings, etc. In some implementations, assets 133 may be rendered using Web Graphics Library (WebGL) or a similar application program interface (API). Assets 133 include restrictions 134.

Restrictions 134 may include restrictions preventing or allowing use of assets 133 based on certain criteria. In some implementations, restrictions 134 may include approved rules for customizing the slides such as predefined rules controlling the colors, fonts, typefaces, and graphics, and other assets 133 that may appear on the slide. In some implementations, a user may modify or customize a slide based on the rules. Restrictions 134 may help the company maintain consistent impressions of goods and services presented by company representatives.

User database 135 is a database of users for system 100. As shown in FIG. 1, user database 135 includes profiles 137, which, in turn, includes permissions 139. In some implementations, user database 135 may include a profile for each person in a company or organization stored in profiles 137. The profile for each person may include a location for the individual, a job description or role of the individual, performance metrics of the individual, etc. In some implementations, permissions 139 may store permissions associated with each person in a company or organization. In other implementations, permissions 139 may store permissions for a subset of people in the company, such as those holding a position allowing the individual to login and customize sales presentations using system 100. In some implementations, permissions may be based on the location of the user, the position of the individual in the organization, and other criteria identified by the organization.

Permissions 137 may include one or more permissions for each user. Each user's permission may be related to the user's rank or position. For example, a junior member of a team may have user permission sufficient to display a presentation using system 100 but may not have a user permission sufficient to modify or customize the presentation. A more senior member may have a user permission sufficient to make changes to an existing presentation, and an executive may have a user permission sufficient to create a new presentation. In some implementations, a permission may be assigned to a user based on a region with which the user is associated, such as a region where the user is positioned. In some implementations, permissions 137 may include permissions to create presentations, customize presentations, modify presentations, or edit presentations.

Executable code 140 is a computer algorithm stored in memory 130 for execution by processor 120 for creating presentations. As shown in FIG. 1, executable code 140 includes smart structure editor 141, master presentation 143, user modified presentation 145, and analytics module 147. Smart structure editor 141 is a computer algorithm stored in memory 130 for execution by processor 120 for creating sales or training presentations customized based on permissions. In some implementations, smart structure editor 141 may identify a user's permissions by comparing a user login received from personal computer 160, identifying the logged-in user in user database 135 by the user's profile in profiles 137. In some implementations, smart structure editor 141 may identify one or more permissions associated with the logged-in user in permissions 139. Master presentation 143 may be the presentation created using smart structure editor 141. User modified presentation 145 may be a user modified copy of master presentation 143 stored for access via the internet or for synchronizing with a presentation stored on personal computer 160.

Analytics module 147 is a computer algorithm stored in memory 130 for execution by processor 120 for collecting data and analytics about viewer interaction with master presentation 143 or user modified presentation 145. Analytics module 147 may record analytics for viewer interactions with presentations, portions of presentations, slide-level interactions with presentations, assets 133 and other in-slide features of presentations.

Personal computer 160 is a personal computing device such as a personal computer, a laptop computer, a tablet computer, a mobile phone, or other personal computing device. Personal computer 160 includes processor 170 and memory 180. Processor 170 is a hardware processor, such as a central processing unit (CPU) used in computing devices. Memory 180 is a non-transitory storage device for storing software for execution by processor 170, and also storing various data and parameters. As shown in FIG. 1, memory 180 includes auto sync module 181 and user presentation 183. Auto sync module 181 is a computer algorithm stored in memory 180 for execution by processor 170 for updating user presentation 183. In some implementations, auto sync module 181 may periodically connect to computing device 110 via network 150 and synchronize presentation 183 with any updates to structure templates, slides, assets, and permissions.

Input device 191 is an input device for receiving input from a user. In some implementations, input device may be a computer keyboard, a computer mouse, a touchscreen input, or other means for receiving input from a user. Display 195 may be a computer monitor, a tablet screen, a mobile phone screen, a projector and display screen, or other display suitable for showing a sales presentation. Speaker 197 is a speaker for playing audio.

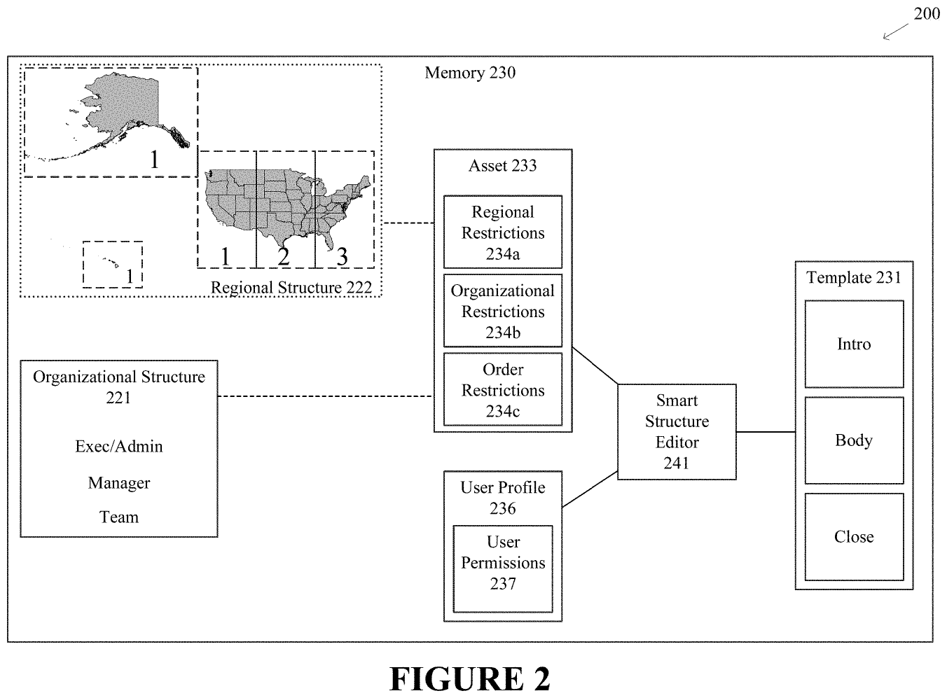

FIG. 2 shows a detail diagram of the web-based sales enablement platforms of FIG. 1, according to one implementation of the present disclosure. Diagram 200 shows organizational structure 221, regional structure 222, assets 233, user profile 236, template 231, and smart structure editor 241. Organizational structure 221 is a structure of a company or organization. In some implementations, the structure may include a hierarchy of roles in the company or organization. As shown in FIG. 2, organizational structure 221 includes an executive/administrative level, a manager level, and a team level. In some implementations, a company or organization may have its own structure and may arrange organizational structure 221 accordingly. Positions or levels in organizational structure 221 may be associated with organizational restrictions 234b.

Regional structure 222 may be a structure of a company or organization defined by a region or regions. As shown in FIG. 2, regional structure 222 shows how the United States may be divided into regions. In some implementations, regional structure 222 may define the regional structure of a company by dividing a territory into regions. For example, a U.S. based company may divide the country into Western Region 1, Central Region 2, and Eastern Region 3. The regions may correspond to time zones, geopolitical boundaries, geographic boundaries, such as mountains and rivers, or arbitrary regions determined the company. For example, a company may define regions may be defined by ease of travel. The different regions stored in regional structure 222 may be associated with regional restrictions 234a.

Regional restrictions 234a may include rules and permissions affecting the use of slides from assets 233 in a particular region. For example, a company may have products or services that are offered in one region but not in another. Accordingly, presentations should be regionalized to show the appropriate content. Regional structure 222 may be used in connection with regional restrictions to allow or disallow asset 233 to be shown in various regions defined by regional structure 222.

Organizational restrictions 234b may be rules restricting access to asset 233 or features of smart structure editor 241 based on a status or rank or other organizational qualification. Organizational restrictions 234b may allow or restrict access or changes based on a user's classification in organizational structure 221. For example, a user with exec/admin level in organizational structure 221 may have the highest level of access allowing the user to create, delete, or change template 231. A user with exec/admin level may have the highest permission available. A user with manager classification in organizational structure 221 may have more restrictions. For example, the manager may only have the ability to edit asset 233 in template 231 but may be restricted from moving or deleting asset 233.

Order restrictions 234c may be rules restricting positioning of asset 233 in template 231. For example, asset 233 may be an asset appropriate for the intro or close section of template 231 but may be restricted from being included in the body section. In some implementations, order restrictions may be relative to other assets. For example, order restrictions 234c may allow repositioning of asset 233 in template 231 but may maintain the position of asset 233 before/after some other asset appearing or used in template 231. A sequence of images showing progression through a process may need to appear in order but including other organizational or regional assets between the ordered assets may be appropriate. Accordingly, a user may not want the sequential assets to be bound together in sequence but may desire regional specific assets to appear between the sequential assets, customizing the presentation for the representative's region.

User profile 236 includes user permissions 237. In some implementations, user permissions 237 may include a clearance level allowing a user to create new presentations, modify existing presentations, customize existing presentations, or edit existing presentations. In some implementations, user permissions 237 may be stored as tags in user profile 236. Smart structure editor 241 may verify user permissions 237 in user profile 236 after a user logs in to use system 100.

Template 231 may be a presentation template, a section template for a portion of a presentation, an individual slide for use in a presentation, or and asset for use in a presentation slide. As shown in FIG. 2, template 231 is a presentation including ordered sections intro, body, and close. In some implementations, the sections in template 231 may correspond to order restrictions 234c.

Smart structure editor 241 may facilitate a user logged in using user profile 236 to create, modify, customize, or edit template 231. In some implementations, smart structure editor 241 may allow certain changes to template 231 based on user permissions 237, regional restrictions 234a, organizational restrictions 234b, and order restrictions 234c. Smart structure editor 241 may receive an input from the user requesting to make a change to template 231. In some implementations, the change may be adding, moving, or deleting an asset, such as asset 233. Smart structure editor 241 may check user permissions 237 to verify the user is permitted to make the requested change. If the request matches or is allowed under user permissions 237, smart structure editor 241 may check regional restrictions 234a, organizational restrictions 234b, and order restrictions 234c. If the requested change is permitted under the restrictions, smart structure editor 241 will make the requested change to template 231.

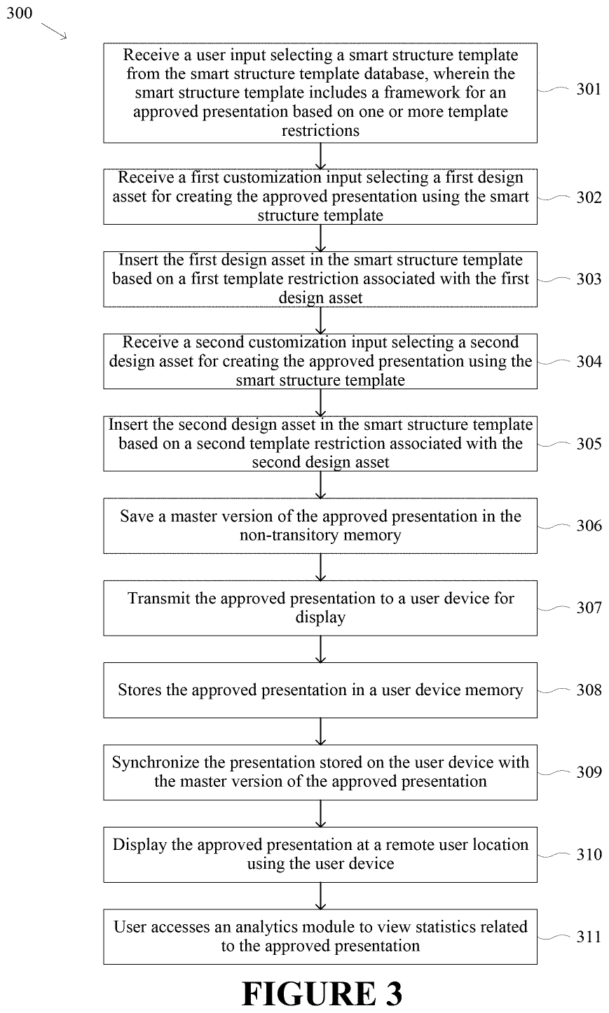

FIG. 3 a flowchart illustrating an exemplary method of web-based sales enablement platforms, according to one implementation of the present disclosure. At 301, hardware processor 120 receives a user input selecting a smart structure template from the smart structure template database, wherein the smart structure template includes a framework for an approved presentation based on one or more template restrictions. The user input may be a selection of a presentation slide template from content database 132. In some implementations, the smart structure template may include a framework for an approved presentation, style, or theme. The smart structure template may include a plurality of presentation sections. By way of nonlimiting example, the presentation may have an introduction, a product or service specific section for highlighting the features of a product or service, a section inviting questions, and a closing section.

In some implementations, each presentation section may be structured to include at least one slide from content database 132 displaying an approved design asset from assets 133. The approved design asset may have an order restriction allowing the user to place asset 133 in the corresponding presentation section.

In some implementations, smart structure editor 141 allows users to create and work with teams. Teams may collaborate on slide presentations, share successes and feedback on slide presentations. Team Space may allow a user to create a “presentation space” and invite team members to join the group to collaboratively create a presentation.

Order restrictions 234c of a slide may allow the user to place the slide in a section of the presentation the user is customizing. In some implementations, a particular slide may have an order restriction allowing the slide to be inserted in the introductory portion of a presentation, the product or service specific section of a presentation, the questions section, the closing section, or any other section the structure template may have. In some implementations, the structure template may include prepopulated slides and may be a pre-determined complete presentation. The user may choose to modify or customize the prepopulated slides or the pre-determined complete presentation. The user's ability to modify or customize the structure template, prepopulated slides, and pre-determined complete presentation may be determined by one or more permissions or restrictions, such as permissions or restrictions associated with the slides, permissions or restrictions associated with presentation assets, and permissions or restrictions associated with the user.

At 302, hardware processor 120 receives a first customization input selecting a first design asset for creating the approved presentation using the smart structure template. In some implementations, the user may select an asset from content database 132 for including in the presentation. The presentation may be an approved presentation by way of including slides and design assets in the presentation based on the permissions or restrictions of the slides and assets. In some implementations, the user may customize a presentation by selecting a design asset from content database 132 and arranging the slides of the presentation or smart structure template based on the permissions or restrictions associated with the design asset or the permissions or restrictions associated with the slide. The design asset may be an allowed asset when the user selects an asset to include in a presentation and the permissions or restrictions associated with the asset correspond to the permissions or restrictions needed for the desired placement of the asset.

In some implementations, a user may choose to customize an existing slide presentation. The user may choose to customize the presentation by adding new slides, removing slides from the presentation, rearranging the order of the slides in a presentation, etc. In other implementations, the user may customize by editing a slide presentation. Editing a slide presentation may include changing certain elements of one or more slides, such as changing a word on a slide or changing the content of a slide. In some implementations, editing a slide may be useful for making a certain slide presentation more regionally appropriate. The ability to edit slides may be determined by permissions or restrictions associated with the slide or the user. For example, an administrator may determine that a regional manager will be allowed to edit slides, but that a sales representative will not be allowed to edit the slide. This type of access restriction may be accomplished by defining the permissions or restrictions for the slide.

In some implementations, the user may customize the slides of a slide presentation. Customizing a slide presentation may include inserting certain content into one or more slides, such as placing a brand-specific image into the slide or updating quarterly sales figures in the slide. In some implementations, customizing a slide may be useful for making a certain slide presentation more client specific.

The ability to customize slides may be determined by permissions or restrictions associated with the slide or the user. For example, an executive or administrator may determine that a regional manager will be allowed to customize slides, but that a sales representative will not be allowed to customize slides. This type of access restriction may be accomplished by setting the restrictions for the slide and the permissions of the user.

At 303, hardware processor 120 inserts the first design asset in the smart structure template based on a first template restriction associated with the first design asset. At 304, hardware processor 120 receive a second customization input selecting a second design asset for creating the approved presentation using the smart structure template. At 305, insert the second design asset in the smart structure template based on a second template restriction associated with the second design asset. At 306, hardware processor 120 saves a master version of the approved presentation in non-transitory memory 130. In some implementations, hardware processor 120 may store the presentation as master presentation 143 and a user modified version as user modified presentation 145. In some implementations, master presentation 143 and user modified presentation 145 may be accessible to a user as a microsite accessible through the internet.

At 307, hardware processor 120 transmits the approved presentation to personal computing device 160. In some implementations, transmission may be over a computer network, such as the internet, by wireless transmission, such as WIFI, cellular, Bluetooth, or other wireless transmission technology. In other implementations, transmission may be accomplished using physical media, such as a wired network, a flash drive, or compact disc (CD) storage. In other implementations, the presentation may be emailed either as a presentation file or as an emailable link for accessing the presentation via the internet. At 308, the user device stores user presentation 183 in user device memory 180.

At 309, system 100 synchronizes user presentation 183 stored on personal computer 160 with the master version of the approved presentation stored in memory 130. In some implementations, synchronization occurs on a periodic basis, such as hourly, daily, or weekly. In other implementations, synchronization may occur in real time and be ongoing. At 310, the approved presentation is displayed by the user device at a remote user location. For example, the presentation may be shown by a salesperson at a client's business location. In some implementations, the presentation may have an audio component played using speaker 197.

At 311, the user may access analytics module 147 to view statistics related to the approved presentation. Analytics module 147 may record data about master presentation 143 and user modified presentation 145, such as a number of views, time spent on a particular slide or asset, interaction with assets such as WebGL graphics or embedded tools. Analytics module 147 may record viewer data by login information, such as a username or email address and use this information to generate viewer-specific analytics and data. Analytics module 147 may record and store granular analytics related to the presentation, sections of the presentation, slides of the presentation, assets of the slides, and individual elements of the slides in the presentation viewed by a user, either master presentation 143 or user modified presentation 145. In some implementations, analytics may be restricted to executive or administrative level users.

The user may present user presentation 183 to an audience at any location. In some implementations, presentation 183 may include the capability to login to another web-based service. For example, during presentation 183 the salesperson may demonstrate the functionality of a feature of a product by logging in to a third-party account, such as an investment account, a bank account, a social media account. In some implementations, presentation 183 may include an inline frame (iframe) capability enabling the user to login to the third-party account. The iframe may enable the user to continue presentation 183 and remain logged in to the third-party account. That way, if the user wants to navigate back to that portion of presentation 183 later, the user will not have to log back into the account. Access to a third-party account during a sales presentation may be useful for showing history and performance of accounts, comparison images, such as before and after photos, etc.

In some implementations, presentation 183 may also include programs such as a Return on Investment (ROI) calculator. This can enable the user to demonstrate the benefit of the product being sold to the customer and can provide a useful tool for closing sales. By including the ROI calculator in the slide presentation, the user will not disrupt the slide presentation by having to switch between programs on the personal computer. The slide presentation may include tools, such as the ability to access a signature collecting program, e.g., DocuSign®, Adobe Sign, etc., enabling the user to close a sale and have a contract signed without exiting the slide presentation.

In some implementations, presentation 183 may include the ability to show a product using augmented reality (AR). For example, when the user is showing presentation 183 on a personal computer with a camera, the system may use augmented reality to show a product to the customer. This may enable the customer to view a product in their office, showroom, or any other setting where a sales meeting may take place. Another application of AR in presentation 183 may be to allow the customer to interact with a virtual device. Allowing the customer to interact in a virtual environment can be a powerful tool to close a sale. In other implementations, the system may include the ability to incorporate a virtual reality experience into presentation 183.

Presentation 183 may include other visualizations, such as using computer generated design graphics to show a product using WebGL. Use of an interactive two-dimensional (2D) or three-dimensional (3D) rendering can also provide an opportunity to include hotspots in presentation 183, where hotspots allow the user to present more in-depth information on a product while the customer interacts with an animated version on the screen.

In some implementations, system 100 will incorporate Talk Track to help users navigate sales meetings. Talk Track allows for a separate version of presentation 183 which is only viewed by the presenter and contains a script or “talk track” for presentation 183 that is being given. In some implementations, this may help the user ensure that certain portions of presentation 183 are addressed.

In some implementations, the system may include a chat function. This may enable nearly instantaneous communication at necessary and urgent times. For example, a salesperson may have created a new slide presentation to show a customer or lead, but the salesperson may need approval of part or all of the new slide presentation before showing it. The chat function may allow the salesperson to transmit the new version and receive a fast response. The chat function may facilitate communication and collaboration in the Team Space, too. Chat may also allow a user to get the most up-to-date information to include in a sales presentation. Chat allows for users to interact and collaborate while creating presentations and new slideware. Chat is a stream within the platform for immediate connectivity with collaborators.

In some implementations, system 100 may include a user dashboard. The dashboard may be where users can access presentations that are saved to their personal account, i.e., the account to which the user logs in at the beginning of the process. Bookmarks may also identify presentations that a company defines and distributes to the larger organization. Bookmarks make preferred, new, or important content easier to locate.

From the above description, it is manifest that various techniques can be used for implementing the concepts described in the present application without departing from the scope of those concepts. Moreover, while the concepts have been described with specific reference to certain implementations, a person having ordinary skill in the art would recognize that changes can be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

What is claimed is:

1. A system comprising:
a non-transitory memory storing a user database, a company database, design assets, a smart structure template database, and an executable code; and
a hardware processor executing the executable code to:
receive a user input selecting a smart structure template from the smart structure template database, wherein the smart structure template includes a framework for an approved presentation based on one or more template restrictions;
receive a first customization input selecting a first design asset for creating the approved presentation using the smart structure template;
insert the first design asset in the smart structure template based on a first template restriction associated with the first design asset;
receive a second customization input selecting a second design asset for creating the approved presentation using the smart structure template;
insert the second design asset in the smart structure template based on a second template restriction associated with the second design asset; and
save a master version of the approved presentation in the non-transitory memory.

2. The system of claim 1, wherein the hardware processor further executes the executable code to transmit the approved presentation to a user device for display.

3. The system of claim 2, wherein the user device stores the approved presentation in a user device memory.

4. The system of claim 2, wherein the approved presentation is stored on the user device is synchronized with the master version of the approved presentation.

5. The system of claim 2, wherein the approved presentation is displayed by the user device at a remote user location.

6. The system of claim 1, wherein the approved presentation includes a link to access a third-party service.

7. The system of claim 1, wherein the approved presentation includes a plurality of sections.

8. The system of claim 1, wherein each design asset has an order restriction that governs a placement of the design asset in the approved presentation.

9. The system of claim 1, wherein the template restrictions include at least one of an order permission, a font permission, a color permission, and a graphics permission.

10. The system of claim 1, wherein the user input is restricted based on a user permission.

11. A method for use with a computer system including a non-transitory memory and a hardware processor, the method comprising:
receiving, using the hardware processor, a user input selecting a smart structure template from a smart structure template database, wherein the smart structure template includes a framework for an approved presentation based on one or more template restrictions;
receiving, using the hardware processor, a first customization input selecting a first design asset for creating the approved presentation using the smart structure template;
inserting, using the hardware processor, the first design asset in the smart structure template based on a first template restriction associated with the first design asset;
receiving, using the hardware processor, a second customization input selecting a second design asset for creating the approved presentation using the smart structure template;
inserting, using the hardware processor, the second design asset in the smart structure template based on a second template restriction associated with the second design asset; and
saving a master version of the approved presentation in the non-transitory memory.

12. The method of claim 11, further comprising transmitting the approved presentation to a user device for display.

13. The method of claim 12, wherein the user device stores the approved presentation in a user device memory.

14. The method of claim 12, wherein the approved presentation stored on the user device is synchronized with the master version of the approved presentation.

15. The method of claim 12, wherein the approved presentation is displayed by the user device at a remote user location.

16. The method of claim 11, wherein the approved presentation includes a link to access a third-party service.

17. The method of claim 11, wherein the approved presentation includes a plurality of sections.

18. The method of claim 11, wherein each design asset has an order restriction that governs a placement of the design asset in the approved presentation.

19. The method of claim 11, wherein the template restrictions include at least one of an order permission, a font permission, a color permission, and a graphics permission.

20. The method of claim 11, wherein the user input is restricted based on a user permission.
